(19) United States
(12) Patent Application Publication
(10) Pub. No.: US 2018/0237120 A1
(43) Pub. Date: Aug. 23, 2018

(54) Aircraft with Under Wing Direct Drive Low Pressure Turbine

(71) Applicant: General Electric Company, Schenectady, NY (US)

(72) Inventors: Brandon Wayne Miller, Liberty Township, OH (US); Richard Byron Stewart, West Chester, OH (US); Jeffrey Donald Clements, Mason, OH (US); Richard David Cedar, Montgomery, OH (US); David William Crall, Loveland, OH (US)

(21) Appl. No.: 15/439,082

(22) Filed: Feb. 22, 2017

(51) Int. Cl. B64C 3/32; F02C 7/36; F02K 3/06; F02C 7/32; B64D 27/18

(52) U.S. Cl. CPC B64C 3/32; F02C 7/36; F02K 3/06; F02C 7/32; F05D 2300/6012; F05D 2220/323; F05D 2300/614; F05D 2300/6033; B64D 27/18

(57) ABSTRACT

The present disclosure is directed to an aircraft including a fuselage to which a pair or more of wings attaches. The aircraft defines a transverse direction, a longitudinal direction, and a latitudinal direction. The aircraft includes a wing extended from the fuselage along the transverse direction in which the wing defines a leading edge, and a gas turbine engine coupled to the wing. The engine defines an axial centerline therethrough along the longitudinal direction. The engine includes a nacelle including an outer wall extended around the axial centerline. The nacelle defines a radial reference plane extended perpendicular from the axial centerline. The outer wall defines an outer wall point closest to the fuselage. The radial reference plane extends through a reference line defined along the latitudinal direction from the outer wall point to the leading edge of the wing. The engine further includes a low pressure (LP) turbine rotor that includes an upstream-most first turbine rotor concentric to the axial centerline. The first turbine rotor is disposed downstream along the longitudinal direction of the radial reference plane.

### FIELD

The present subject matter relates generally to gas turbine engine architecture.

### BACKGROUND

Aircraft, such as commercial airliners, generally includes gas turbine engines mounted forward of a leading edge of a wing of the aircraft. In known configurations, at least the rotary members of the gas turbine engine (e.g., the turbine section, the compressor section, and the fan assembly) are disposed forward of the leading edge to mitigate risks relative to rotor failure.

Among direct drive gas turbine engines, a low pressure (LP) turbine and the fan assembly are each coupled to a LP shaft to define an LP spool without a reduction gearbox therebetween (i.e. the LP turbine and the fan assembly rotate at approximately the same rotational speed). In contrast, indirect drive gas turbine engines (e.g., geared turbofans) include a reduction gearbox disposed between the fan assembly and the LP turbine rotor. The gearbox generally proportionally reduces the fan assembly speed relative to the LP turbine rotor. Therefore, indirect drive LP turbine rotors generally rotate at greater speeds compared to direct drive LP turbine rotors. For example, some indirect drive LP turbines may rotate approximately three times the speed of a direct drive LP turbine.

However, increased efficiencies due to the faster rotating LP turbine and relatively low speed fan assembly are at least partially offset by increased risks to engines and the aircraft due to rotor failure (e.g., disks, hubs, drums, seals, impellers, blades, and/or spacers). Therefore, known indirect drive LP turbines generally require additional structures to at least reduce such risks to those comparable with the relatively low speed direct drive turbine.

Still further, indirect drive engine architecture introduces additional systems and assemblies (e.g., the reduction gearbox) relative to direct drive engines that generate other performance debits and aircraft risks. For example, in addition to risks from a relatively high speed LP turbine, the reduction gearbox adds weight, complexity, and novel failure modes to the engine and aircraft.

Therefore, there is a need for an aircraft including a direct drive engine that may include structural and risk benefits from a relatively low speed LP turbine while also improving aircraft efficiency.

### BRIEF DESCRIPTION

Aspects and advantages of the invention will be set forth in part in the following description, or may be obvious from the description, or may be learned through practice of the invention.

The present disclosure is directed to an aircraft including a fuselage to which a pair or more of wings attaches. The aircraft defines a transverse direction, a longitudinal direction, and a latitudinal direction. The aircraft includes a wing extended from the fuselage along the transverse direction in which the wing defines a leading edge, and a gas turbine engine coupled to the wing. The engine defines an axial centerline therethrough along the longitudinal direction. The engine includes a nacelle including an outer wall extended around the axial centerline. The nacelle defines a radial reference plane extended perpendicular from the axial centerline. The outer wall defines an outer wall point closest to the fuselage. The radial reference plane extends through a reference line defined along the latitudinal direction from the outer wall point to the leading edge of the wing. The engine further includes a low pressure (LP) turbine rotor that includes an upstream-most first turbine rotor concentric to the axial centerline. The first turbine rotor is disposed downstream along the longitudinal direction of the radial reference plane.

In one embodiment, the engine defines a top dead center (TDC) reference plane extended in the latitudinal direction from the axial centerline and intersecting the leading edge of the wing, and the engine further defines a second radial reference plane extended perpendicular from the axial centerline at the intersection of the TDC reference plane. The LP turbine is disposed downstream along the longitudinal direction of the second radial reference plane.

In another embodiment, the nacelle defines a third radial reference plane extended perpendicular from the axial centerline and extended through a third reference line defined along the latitudinal direction from a second outer wall point to the leading edge of the wing, and the second outer wall point is farthest from the fuselage on the outer wall. The LP turbine is disposed downstream along the longitudinal direction of the third radial reference plane.

In yet another embodiment, the gas turbine engine further includes an outer casing. The outer casing includes an outer casing wall extended around the axial centerline. The outer casing defines a fourth radial reference plane extended perpendicular from the axial centerline. The outer casing wall defines an outer casing wall point closest to the fuselage on the outer casing wall. The fourth radial reference plane extends through a fourth reference line defined along the latitudinal direction from the outer casing wall point to the leading edge of the wing. The LP turbine is disposed downstream along the longitudinal direction of the fourth radial reference plane.

In still another embodiment, the outer casing defines a fifth radial reference plane extended perpendicular from the axial centerline. The outer casing wall defines a second outer casing wall point farthest from the fuselage on the outer casing wall. The fifth radial reference plane extends through a fifth reference line defined along the latitudinal direction from the second outer casing wall point to the leading edge of the wing. The LP turbine is disposed downstream along the longitudinal direction of the fifth radial reference plane.

In various embodiments, wherein the LP turbine of the gas turbine engine includes a last turbine rotor at a downstream-most end of the LP turbine. The LP turbine defines a turbine burst area inward of the wing along the latitudinal direction and extended at a first angle along a plane of rotation of the first turbine rotor toward the upstream end and at a second angle along a plane of rotation of the last turbine rotor toward the downstream end of the gas turbine engine. In one embodiment, the first angle of the turbine burst area is approximately 15 degrees or less. In another embodiment, the first angle of the turbine burst area is approximately 3 degrees or more. In still another embodiment, the second angle of the turbine burst area is approximately 15 degrees or less. In still yet another embodiment, the second angle of the turbine burst area is approximately 3 degrees or more. In yet still another embodiment, the turbine burst area inward of the wing toward the engine is defined downstream of the leading edge and forward of a trailing edge of the wing along the longitudinal direction.

In still various embodiments, the aircraft further includes a containment shield extended over the LP turbine along the longitudinal direction approximately from the first turbine rotor to the last turbine rotor, in which the containment shield extends at least within a transverse turbine burst area extended generally clockwise and/or counter-clockwise from a TDC reference plane extended from the axial centerline along the latitudinal direction. In one embodiment, the containment shield is coupled to the wing of the aircraft and extended generally along the transverse direction. In another embodiment, the containment shield is coupled to an outer casing of the engine extended generally along the longitudinal direction, wherein the containment shield extends at least partially along a circumferential direction, defined around the axial centerline, from the TDC reference plane along the clockwise and/or counter-clockwise direction. In still another embodiment, the containment shield extends approximately entirely around the LP turbine along the circumferential direction. In still yet various embodiments, the containment shield is formed from a plurality of fabric sheets formed from a plurality of fibers. In yet another embodiment, the plurality of fibers includes para-aramid synthetic fibers, metal fibers, ceramic fibers, glass fibers, carbon fibers, boron fibers, p-phenylenetherephtalamide fibers, aromatic polyamide fibers, silicon carbide fibers, graphite fibers, nylon fibers, ultra-high molecular weight polyethylene fibers, or mixtures thereof.

In various embodiments, the aircraft further includes a fan assembly and a driveshaft. The fan assembly includes a plurality of fan blades rotatably coupled to a fan rotor. The driveshaft is coupled to the fan rotor. The LP turbine is coupled to the driveshaft and disposed downstream of the fan assembly and defines a direct drive gas turbine engine. In one embodiment, the fan assembly, the LP turbine, and the driveshaft of the gas turbine engine together define a low pressure spool that rotates about an axial centerline of the gas turbine engine at approximately 6000 RPM or less.

In one embodiment of the aircraft, the wing defines a wing shear center, and the engine includes an exhaust nozzle disposed downstream of the LP turbine. The exhaust nozzle defines a downstream-most end that is approximately equal to the wing shear center along the longitudinal direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of an exemplary embodiment of an aircraft including a direct drive engine according to an aspect of the present disclosure;

FIG. 2 is a top looking down view of an embodiment of the aircraft and engine shown in FIG. 1;

FIG. 3 is a transverse side view of the aircraft and engine shown in FIG. 2;

FIG. 4 is a top looking down view of another exemplary embodiment of the aircraft and engine shown in FIG. 1;

FIG. 5 is a transverse side view of the embodiments of the aircraft and engine shown in FIG. 4;

FIG. 6 is a cross sectional view of an exemplary embodiment of a gas turbine engine attached to a wing and pylon of an aircraft;

FIG. 7 is a cross sectional view of another exemplary embodiment of a gas turbine engine attached to a wing and pylon of an aircraft; and

FIG. 8 is a transverse side view of an exemplary embodiment of the aircraft shown in FIG. 7.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows. Unless otherwise stated, “downstream” and “upstream” refer to the general direction of fluid flow of air or resulting combustion gases through a core flowpath of the engine from entry in the compressor section through exit from a turbine section.

Embodiments of an aircraft are generally provided including a direct drive gas turbine engine that may include structural and risk benefits from a relatively low speed LP turbine while also improving aircraft efficiency. The embodiments shown and described herein dispose the LP turbine of the engine underneath the wing of the aircraft. In various embodiments, a containment structure is further provided to mitigate risks to the aircraft associated with turbine rotor burst.

In contrast to indirect drive engine configurations with high speed LP turbines, the embodiments shown and described herein may improve aircraft efficiency without the added systems, complexities, failure modes, or risks of an indirect drive engine. In various embodiments, approximately 318 kilograms (kg) of aircraft weight may be reduced for every 51 millimeter (mm) shift in a center of gravity of the gas turbine engine toward a leading edge of a wing of the aircraft along a longitudinal direction. In still various embodiments, shifting the center of gravity of the gas turbine engine toward the leading edge of the wing may improve aircraft fuel burn by 0.5% for every 51 mm shift. The embodiments described herein may further remove weight, parts, and risks unique to indirect drive engines relative to reduction gearbox failure.

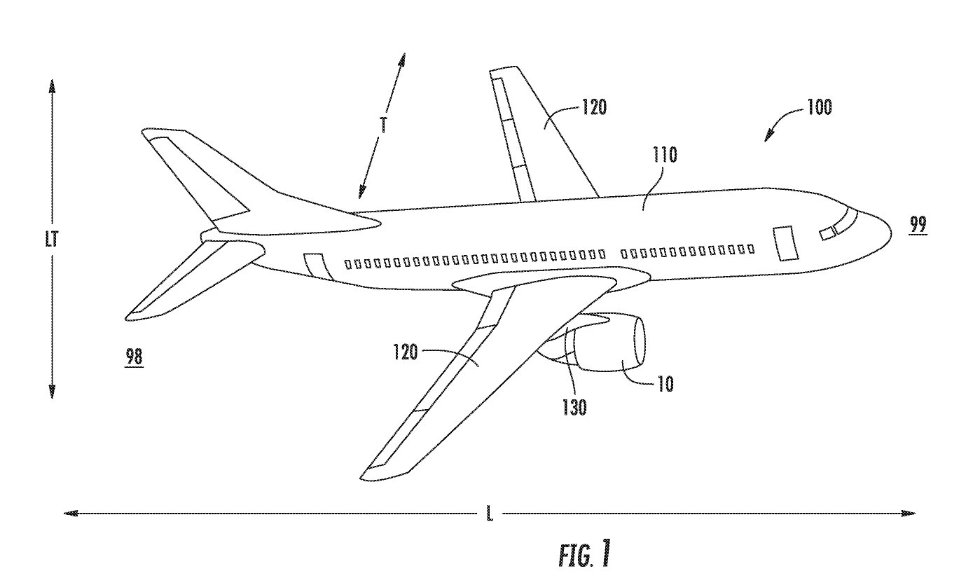

Referring now to FIG. 1, an exemplary embodiment of an aircraft 100 is generally provided. The aircraft 100 defines a longitudinal direction LO, transverse direction T, a latitudinal direction LT, and an upstream end 99 and a downstream end 98 along the longitudinal direction LO. The aircraft 100 includes a fuselage 110 extended generally along the longitudinal direction LO. A pair of wings 120 each extend from the fuselage 110 of the aircraft 100 generally along the transverse direction T. Each wing 120 includes a pylon 130 to which one or more gas turbine engines 10 (hereinafter “engine 10”) attaches underneath the wing 120 (e.g., inward along the latitudinal direction LT). Each wing 120 further defines a leading edge 122 and a trailing edge 124. In various embodiments as shown and described herein, the exemplary embodiments of the engines 10 define a direct drive engine in which a low pressure turbine rotor attaches to a fan rotor without a reduction gearbox therebetween.

It should be understood that references to “upstream-most end”, or “upstream of”, are relative to a component or part toward the upstream end 99 as shown in the figures and generally understood in the art as the direction from which a fluid comes before and as it passes the area, part, or component in question. Similarly, references to “downstream-most end” or “downstream of” are relative to a component or part toward the downstream end 98 and is generally understood in the art as the direction to which a fluid goes as it passes the area, part, component, or structure in reference thereto. It should further be understood that reference lines, reference planes, or points as provided herein are used to define relative locations, placements, or dispositions of structures, elements, features, components, parts, etc. shown and included herein.

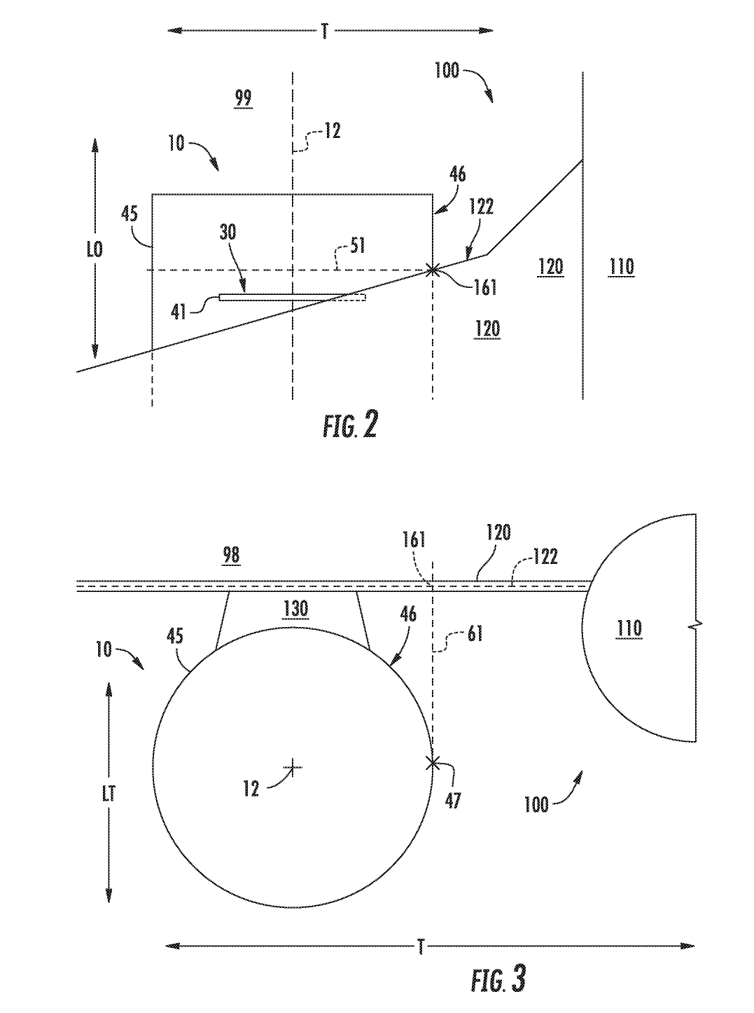

A top looking down view of the aircraft 100 shown in FIG. 1 is generally provided in FIG. 2. A transverse side view of the aircraft shown in FIG. 1 is generally provided in FIG. 3. Referring to FIGS. 2 and 3, the engine 10 coupled to the wing 120 defines an axial centerline 12 through the engine 10 along the longitudinal direction LO. The engine 10 includes a nacelle 45 and a low pressure (LP) turbine 30. The nacelle 45 includes an outer wall 46 extended around the axial centerline 12. The LP turbine 30 includes an upstream-most first turbine rotor 41 concentric to the axial centerline 12.

The nacelle 45 defines a radial reference plane 51 extended perpendicular from the axial centerline 12 (i.e., the radial reference plane 51 extends generally along the transverse direction T). The outer wall 46 defines an outer wall point 47 closest to the fuselage 110. A reference line 61 is defined along the latitudinal direction LT from the outer wall point 47 to the leading edge 122 of the wing 120. The radial reference plane 51 extends through the reference line 61. The first turbine rotor 41 of the LP turbine 30 is disposed downstream along the longitudinal direction LO of the radial reference plane 51.

Referring to the top looking down view of the aircraft 100 shown in FIG. 2, the reference line 61 extended along the latitudinal direction LT to the leading edge 122 defines a leading edge point 161. The leading edge point 161 is a point through which the radial reference plane 51 extends perpendicular from the axial centerline 12. In other words, viewed from the two dimensions shown in FIG. 2 (the longitudinal direction LO and the transverse direction T), the leading edge point 161 appears to be a point at which the leading edge 122 intersects the outer wall 46 of the nacelle 45 closest to the fuselage 110, although it should be understood that the nacelle 45 and the leading edge 122 do not generally intersect in three-dimensional space. Therefore, the radial reference plane 51, when viewed from the two dimensions shown in FIG. 2, appears as a line extended along the transverse direction T, perpendicular to the axial centerline 12 and including the leading edge point 161. The first turbine rotor 41 of the LP turbine 30 is disposed downstream along the longitudinal direction LO of the radial reference plane 51.

The engine 10 including the LP turbine 30 disposed aft or downstream of the radial reference plane 51 may reduce overhung mass in the wing 120 and pylon 130 (shown in FIG. 1). Additionally, disposing the LP turbine 30 aft or downstream of the radial reference plane 51 may enable shifting a center of gravity of the engine 10 toward the wing 120, and thereby reducing a moment arm produced by the engine 10 against the wing 120 and pylon 130. Reducing the weight and moment arm against the aircraft 100 together with a relatively low speed LP turbine 30 of the engine 10 may enable reductions in overall aircraft fuel consumption and increased aircraft efficiency without the added complexity and risks of an indirect drive engine (i.e., a reduction gearbox) or risks associated with a relatively high speed LP turbine. Still further, performance debits resulting from added containment structures for an under-wing LP turbine 30 may be relatively less than performance debits resulting from added weight and risk due to a reduction gearbox.

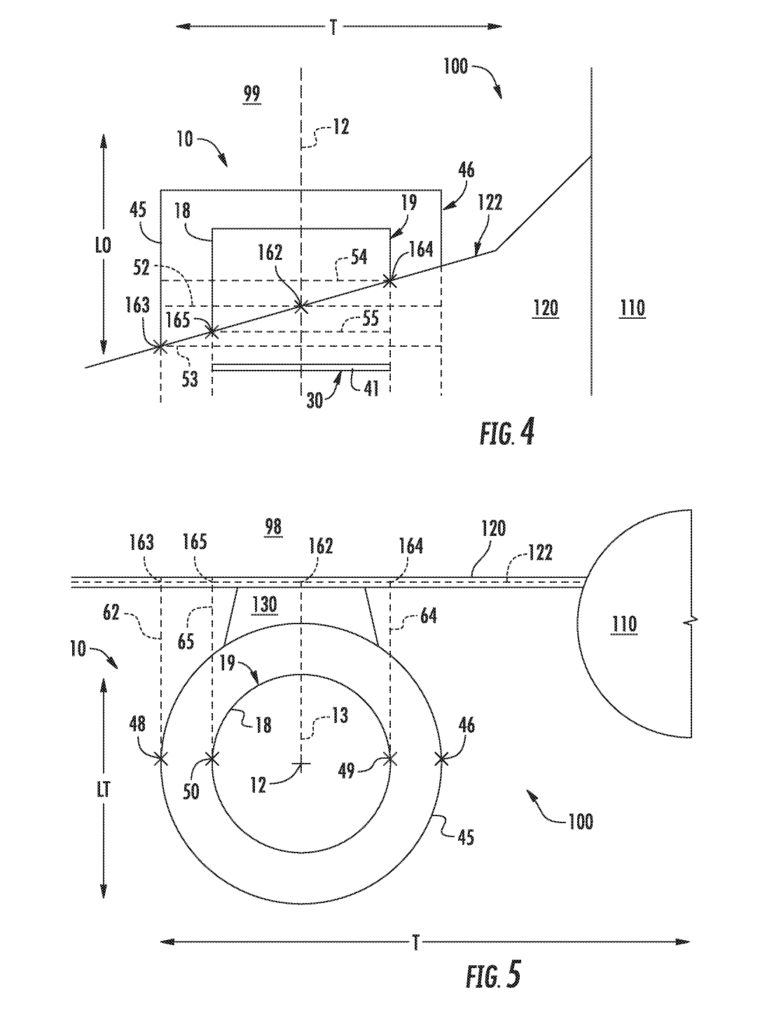

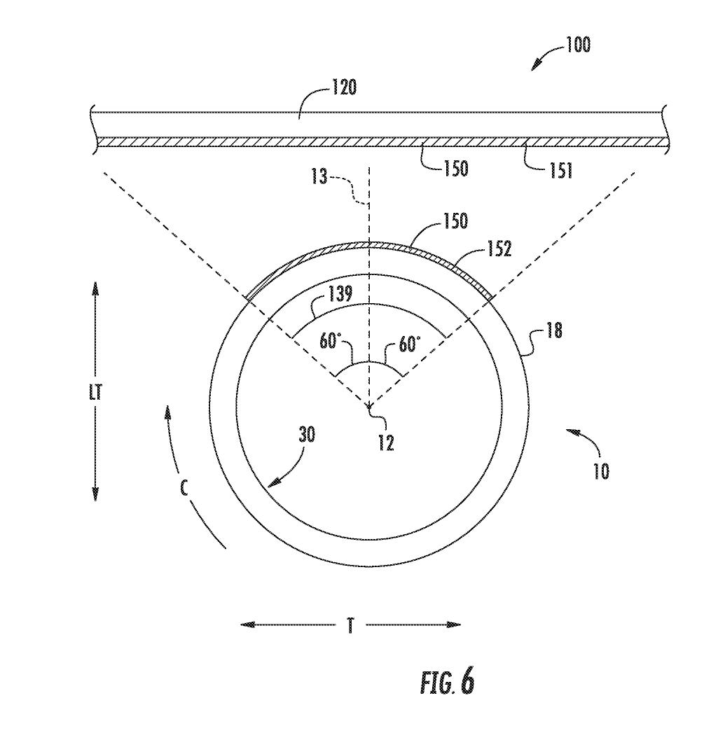

Referring now to FIGS. 4 and 5, another exemplary embodiment of a top looking down view of the aircraft 100 is generally provided in FIG. 4 and a corresponding transverse side view is generally provided in FIG. 5. The views provided in FIGS. 4 and 5 together provide similar reference points, lines, and planes as discussed in regard to FIGS. 2 and 3. However, in the embodiments shown in FIGS. 4 and 5, the engine 10 defines a top dead center (TDC) reference plane 13 extended in the latitudinal direction LT from the axial centerline 12 and intersecting the leading edge 122 of the wing 120 to define a second leading edge point 162. The engine 10 may further define a second radial reference plane 52 extended perpendicular from the axial centerline 12 at the intersection of the TDC reference plane 13. The LP turbine 30 is disposed downstream of the second reference plane 52 along the longitudinal direction LO.

As discussed in regard to FIG. 2, when viewed from the two dimensions shown in FIG. 4 (the longitudinal direction LO and the transverse direction T), the second leading edge point 162 appears to be a point at which the leading edge 122 intersects the axial centerline 12, although it should be understood that the axial centerline 12 does not intersect the leading edge 120 in three dimensional space. Therefore, the second radial reference plane 52, when viewed from the two dimensions shown in FIG. 4, appears as a line extended along the transverse direction T, perpendicular to the axial centerline 12 and including the second leading edge point 162. The first turbine rotor 41 of the LP turbine 30 is disposed downstream along the longitudinal direction LO of the second radial reference plane 52.

Referring still to FIG. 4, yet another exemplary embodiment is generally provided showing the LP turbine 30 relative to the leading edge 122 of the wing 120. The nacelle 45 may define a third radial reference plane 53 extended perpendicular from the axial centerline 12. The outer wall 46 defines a second outer wall point 48 farthest from the fuselage 110. A second reference line 62 is defined along the latitudinal direction LT from the second outer wall point 48 to the leading edge 122 of the wing 120. The third radial reference plane 53 extends through the second reference line 62. The first turbine rotor 41 of the LP turbine 30 is disposed downstream along the longitudinal direction LO of the third radial reference plane 53.

As discussed in regard to FIG. 2, when viewed from the two dimensions shown in FIG. 4 (the longitudinal direction LO and the transverse direction T), a third leading edge point 163 appears to be a point at which the leading edge 122 intersects the outer wall 46 of the nacelle 45 farthest from the fuselage 110, although it should be understood that the nacelle 45 and the leading edge 122 do not generally intersect in three-dimensional space. Therefore, the third radial reference plane 53, when viewed from the two dimensions shown in FIG. 4, appears as a line extended along the transverse direction T, perpendicular to the axial centerline 12 and including the third leading edge point 163. The first turbine rotor 41 of the LP turbine 30 is disposed downstream along the longitudinal direction LO of the third radial reference plane 53.

Referring still to FIGS. 4 and 5, another exemplary embodiment of the engine 10 is provided in which the engine 10 further includes an outer casing 18. The outer casing includes an outer casing wall 19 extended around the axial centerline 12. The outer casing 18 defines a fourth radial reference plane 54 extended perpendicular from the axial centerline 12. The outer casing wall 19 defines an outer casing point 49 closest to the fuselage 110 on the outer casing wall 19. The fourth radial reference plane 54 extends through a fourth reference line 64 defined along the latitudinal direction LT from the outer casing wall point 49 to the leading edge 122 of the wing 120. The LP turbine 30 is disposed downstream of the fourth radial reference plane 54 along the longitudinal direction LO.

In still another exemplary embodiment of the engine 10, the outer casing 18 defines a fifth radial reference plane 55 extended perpendicular from the axial centerline 12. The outer casing wall 19 defines a second outer casing point 50 farthest from the fuselage 110 on the outer casing wall 19. The fifth radial reference plane 55 extends through a fifth reference line 65 defined along the latitudinal direction LT from the second outer casing wall point 50 to the leading edge 122 of the wing 120. The LP turbine 30 is disposed downstream of the fifth radial reference plane 55 along the longitudinal direction LO.

As discussed in regard to other embodiments of the engine 10 and aircraft 100 in regard to FIGS. 2 and 4, when viewed from the two dimensions shown in FIG. 4 (the longitudinal direction LO and the transverse direction T), a fourth leading edge point 164 appears to be a point at which the leading edge 122 intersects the outer casing wall 19 of the outer casing 18 closest to the fuselage 110. In another embodiment, a fifth leading edge point 165 appears to be a point at which the leading edge 122 intersects the outer casing wall 19 of the outer casing 18 farthest from the fuselage 110. It should be understood that the outer casing 18 and the leading edge 122 do not generally intersect in three-dimensional space and that the two-dimensional reference shown in FIG. 4 is to show and define the position of the LP turbine 30 relative to specific portions of the leading edge 122 of the wing 120. Therefore, the fourth and fifth radial reference planes 54, 55, when viewed from the two dimensions shown in FIG. 4, appears as a line extended along the transverse direction T, perpendicular to the axial centerline 12 and including the fourth and fifth leading edge points 164, 165, respectively. In one embodiment, the first turbine rotor 41 of the LP turbine 30 is disposed aft or downstream of the fourth radial reference plane 64 along the longitudinal direction LO. In another embodiment, the first turbine rotor 41 is disposed aft or downstream of the fifth radial reference plane 65 along the longitudinal direction LO.

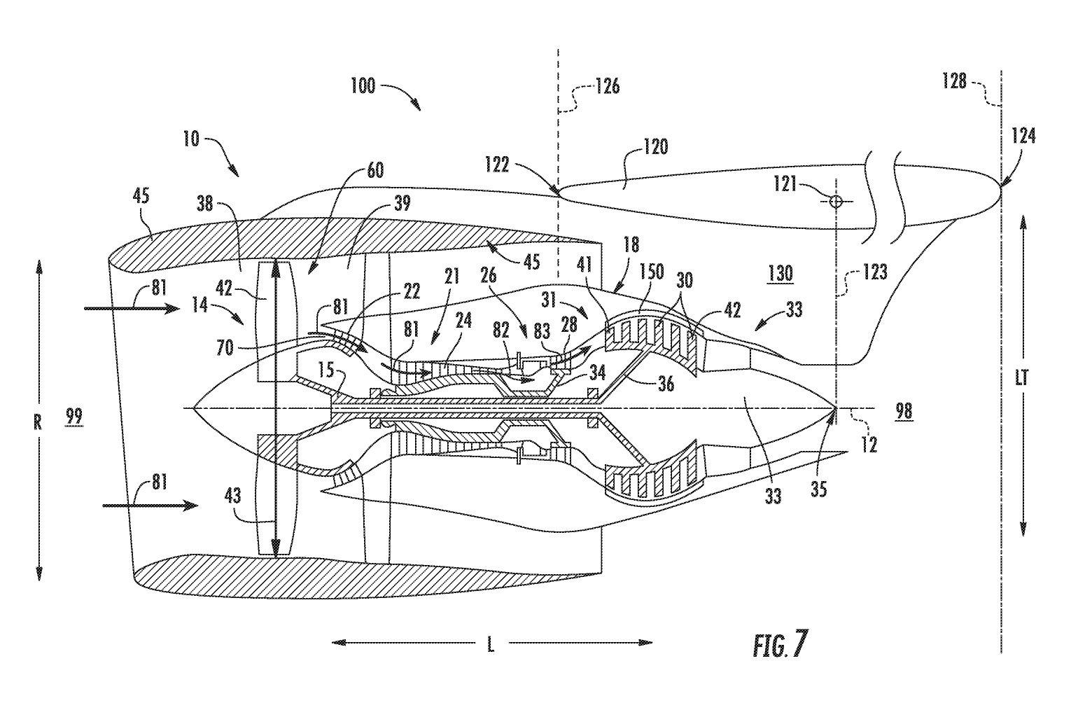

Referring now to FIG. 6, an exemplary embodiment of a portion of the aircraft 100 is generally provided. FIG. 6 provides further detail as to the relative placement of the engine 10 to the wing 120 of the aircraft 100 such that overall aircraft efficiency is improved while defining the relative risks, and mitigations thereof, of a direct drive engine. In various embodiments of the aircraft 100, the wing 120 further defines a wing shear center 121. The wing shear center 121 defines a point through which shear loads produce no twisting of the wing 120. The wing shear center 121 may further define a center of twist when torsional loads are applied to the wing 120.

Referring still to FIG. 6, the engine 10 includes, in serial flow arrangement along a longitudinal direction LO, a fan assembly 14, a compressor section 21, a combustion section 26, a turbine section 31, and an exhaust nozzle assembly 33. The engine 10 extends generally along the longitudinal direction LO, in which the exhaust nozzle assembly 33 defines a downstream-most end 35 that may be disposed approximately equal to the wing shear center 121 along the longitudinal direction LO. In various embodiments, disposing the downstream-most end 35 of the exhaust nozzle assembly 33 may further shift the engine 10 aft or downstream toward the wing shear center 121, and thereby reduce a moment arm of the engine 10 acting from the wing shear center 121. Reducing the moment arm from the wing shear center 121 may further reduce weight of the wing 120 and/or pylon 130, thereby improving aircraft efficiency, such as fuel consumption.

The compressor section 21 generally includes a low pressure (LP) compressor 22 and a high pressure (HP) compressor 24 in serial flow arrangement from the upstream end 99 to the downstream end 98. The turbine section 31 generally includes an HP turbine 28 and an LP turbine 30 in serial flow arrangement from the upstream end 99 to the downstream end 98. The combustion section 26 is disposed between the HP compressor 24 and the HP turbine 28. The HP compressor 24 and the HP turbine 28, with an HP shaft 34 rotatably coupling each, together define an HP spool. Although depicted herein as a two spool direct drive engine, it should be understood that the engine 10 may further include an intermediate pressure (IP) compressor and an IP turbine coupled together by an IP shaft and altogether defining an IP spool, thus defining a three spool direct drive engine configuration.

The fan assembly 14 includes a plurality of fan blades 42 rotatably coupled to a fan rotor 15. The fan rotor 15 is rotatably coupled toward the upstream end 99 of a driveshaft 36 extended along the longitudinal direction LO. The LP turbine 30 is coupled to the driveshaft 36 toward the downstream end 98 of the driveshaft 36. In one embodiment, the fan assembly 14, LP compressor 22, driveshaft 36, and the LP turbine 30 together define an LP spool. In other embodiments, such as with a three spool direct drive configuration, the fan assembly 14, driveshaft 36, and the LP turbine 30 may together define the LP spool. In various embodiments, the LP turbine 30 defines at least two rotating stages. In another embodiment, the LP turbine 30 defines eight or fewer rotating stages.

During operation of the engine 10, a drive motor begins rotation of the HP spool, which introduces air, shown schematically as arrows 81, into a core flowpath 70 of the engine 10. The air 81 passes across successive stages of the LP compressor 22 and the HP compressor 24 and increases in pressure to define compressed air 82 entering the combustion section 26. Fuel is introduced to the combustion section 26 and mixed with the compressed air 82 then ignited to yield combustion gases 83. Energy from the combustion gases 83 drives rotation of the HP turbine 28 and the LP turbine 30, as well as their respective HP and LP spools, and the fan assembly 14 and compressor section 21 to which each are attached. In one embodiment, the LP spool rotates about the axial centerline 12 at approximately 6000 revolutions per minute (RPM) or less. In another embodiment, the LP spool rotates about the axial centerline 12 at approximately 4000 RPM or less.

The cycle of introducing air 81 into the core flowpath 70, mixing with fuel, igniting, and producing combustion gases 83 provides energy to rotate the plurality of fan blades 42 about an axial centerline 12 of the engine 10. A portion of air 81 passes through a bypass duct 60 defined between a nacelle 45 and an outer casing 18 of the engine 10. The outer casing 18 is substantially tubular and surrounding the compressor section 21, the combustion section 26, and the turbine section 31 generally along the longitudinal direction LO. In the embodiment described herein, the nacelle 45 may further include a fan case. The outer casing 18 may further include a cowl defining a generally aerodynamic flowpath of the bypass duct 60.

Referring still to the embodiment shown in FIG. 6, the LP turbine 30 is disposed inward of the wing 120 along the latitudinal direction LT. The LP turbine 30 is disposed between the leading edge 122 and the trailing edge 124 of the wing 120 along the longitudinal direction LO.

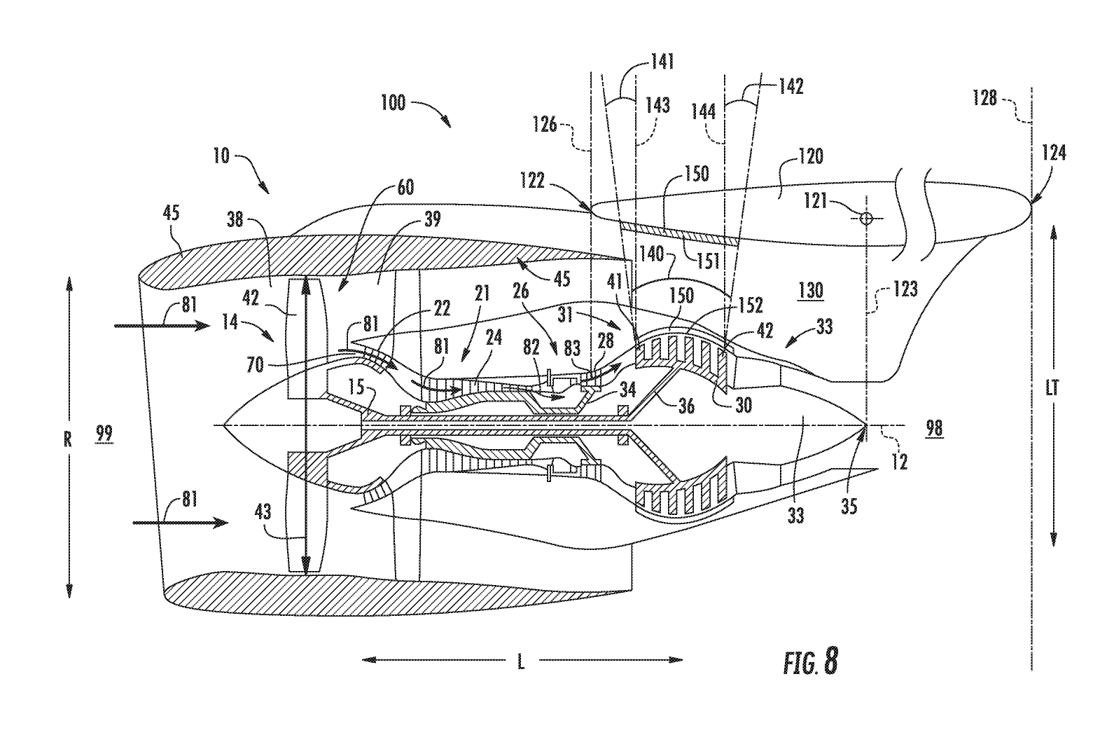

Referring now to FIG. 7, another exemplary embodiment of the portion of the aircraft 100 shown in FIGS. 1-6 is generally provided. In the embodiment shown in FIG. 7, and in conjunction with FIGS. 1-5, the LP turbine 30 of the engine 10 defines the first turbine rotor 41 at an upstream-most end of the LP turbine 30 and a last turbine rotor 42 at a downstream-most end of the LP turbine 30. The LP turbine 30 defines a turbine burst area 140 extended at a first angle 141 along a plane of rotation 143 of the first turbine rotor 41 toward the upstream end 99 of the gas turbine engine 10, and at a second angle 142 along a plane of rotation 144 of the last turbine rotor 42 toward the downstream end 98 of the gas turbine engine 10. Each plane of rotation 143, 144 extends along a radial direction R extended from the axial centerline 12.

Referring to FIG. 7, in one embodiment, the first angle 141 of the turbine burst area 140 is approximately 15 degrees or less. In another embodiment, the first angle 141 of the turbine burst area 140 is approximately 3 degrees or more.

Referring still to FIG. 7, in one embodiment, the second angle 142 of the turbine burst area 140 is approximately 15 degrees or less. In another embodiment, the second angle 142 of the turbine burst area 140 is approximately 3 degrees or more.

Referring now to FIGS. 1-7, in various embodiments, the turbine burst area 140 inward of the wing 120 along the latitudinal direction LT is defined within the leading edge 122 and the trailing edge 124 of the wing 120 along the longitudinal direction LO.

Defining the turbine burst area 140 inward of the wing 120 along the latitudinal direction LT, and between the leading edge 122 and the trailing edge 124 of the wing 120 along the longitudinal direction LO, may reduce pylon 130 and wing 120 weight by shifting the engine 10 toward the wing shear center 121 along the longitudinal direction LO. Shifting the engine 10 toward the wing shear center 121 may reduce aircraft 100 weight and thereby increase aircraft efficiency. While further defining a direct drive engine, the overhung weight from the pylon 130 and the engine 10 may be reduced due to an absence of a reduction gearbox toward the upstream end 99 of the engine 10, thereby increasing the moment arm from the wing shear center 121, and ultimately, aircraft weight and inefficiency. By disposing the turbine burst area 140 within the forward plane 126 and the aft plane 128 of the wing 120, the weight of the pylon 130 and wing 120 are reduced while also maintaining risks and failure modes similar to and known among direct drive engines.

Referring now to FIGS. 7 and 8, embodiments of the aircraft 100 and engine 10 are generally provided, in which a containment shield 150 is further defined. In FIG. 8, a planar view of the aircraft 100 is provided along either plane of rotation 143, 144. The containment shield 150 is extended over the LP turbine 30 along the longitudinal direction LO. In various embodiments, the containment shield 150 extends from the first turbine rotor 41 through the last turbine rotor 42 along the longitudinal direction LO. The containment shield 150 provides retention of LP turbine 30 rotor components that may liberate following a rotor failure. Rotor components may include disks, hubs, drums, seals, impellers, blades, and/or spacers, or fragments thereof, which may eject from the engine 10 generally within the turbine burst area 140.

In various embodiments, the containment shield 150 extends at least within a transverse turbine burst area 139. The transverse turbine burst area 139 may generally extend clockwise and/or counter-clockwise from a TDC reference plane 13. The TDC reference plane 13 is extended from the axial centerline 12 at zero degrees along the radial direction R. In one embodiment, the transverse turbine burst area 139 extends approximately 60 degrees or less clockwise and/or counter-clockwise from the TDC reference plane 13.

In one embodiment, the containment shield 150 may be coupled to the wing 120 of the aircraft 100, as shown at the first containment shield 151. The first containment shield 151 extends generally along the transverse direction T and within the transverse turbine burst area 139. In another embodiment, the containment shield 150 may be coupled to the outer casing 18 of the engine 10, as shown at the second containment shield 152. The second containment shield 152 extends at least partially in a circumferential direction C from the TDC reference plane 13 extended from the axial centerline 12 of the engine 10. In various embodiments, the second containment shield 152 extends along the clockwise and/or counter-clockwise direction along the circumferential direction C from the TDC reference plane 13. In yet another embodiment, the second containment shield 152 may extend substantially circumferentially around the LP turbine 30 along the circumferential direction C (e.g., approximately 360 degrees).

The containment shield 150 may be constructed of, but not limited to, ceramic matrix composite (CMC) materials and/or metals appropriate for gas turbine engine containment structures, such as, but not limited to, nickel-based alloys, cobalt-based alloys, iron-based alloys, or titanium-based alloys, each of which may include, but are not limited to, chromium, cobalt, tungsten, tantalum, molybdenum, and/or rhenium.

The containment shield 150 may further, or alternatively, include a solid foamed synthetic polymer. In one embodiment, the solid foamed synthetic polymer may include a synthetic elastomer, such as an elastomeric polyurethane. In another embodiment, the solid foamed synthetic polymer may include an ethylene vinyl acetate and/or an olefin polymer.

In another embodiment, the containment shield 150 is formed from a plurality of fabric sheets formed from a plurality of fibers. In each sheet, the plurality of fibers may form a network of fibers (e.g., a woven network, a random or parallel nonwoven network, or another orientation). In particular, the containment shield 150 may be constructed from high strength and high modulus fibers, such as para-aramid synthetic fibers (e.g., KEVLAR fibers available from E.I. duPont de Nemours and Company), metal fibers, ceramic fibers, glass fibers, carbon fibers, boron fibers, p-phenylenetherephtalamide fibers, aromatic polyamide fibers, silicon carbide fibers, graphite fibers, nylon fibers, or mixtures thereof. Another example of suitable fibers includes ultra-high molecular weight polyethylene (e.g., SPECTRA fibers manufactured by Honeywell International Inc.).

The fibers of the containment shield 150 may have high tensile strength and high modulus that are highly oriented, thereby resulting in very smooth fiber surfaces exhibiting a low coefficient of friction. Such fibers, when formed into a fabric layer, generally exhibit poor energy transfer to neighboring fibers during intermittent transfers of energy or torque from rotor failure of the LP turbine 30 to surrounding structures, such as the outer casing 18 and/or the wing 120 of the aircraft 100.

The systems shown in FIGS. 1-8 and described herein may improve aircraft efficiency utilizing direct drive gas turbine engines by reducing a moment arm from the wing shear center 121 to the upstream end 99 of the engine 10, thereby reducing weight of the wing 120, pylon 130, and/or engine 10. Furthermore, the systems disclosed herein may improve aircraft 100 efficiency while utilizing direct drive gas turbine engines while obviating additional subsystems, risks, and failure modes introduced by indirect drive engines. Improvements to aircraft efficiency may include decreased weight, decreased system failure risks, and improved overall aircraft fuel burn.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An aircraft including a fuselage to which a pair or more of wings attaches, wherein the aircraft defines a transverse direction, a longitudinal direction, and a latitudinal direction, the aircraft comprising:
a wing extended from the fuselage along the transverse direction, wherein the wing defines a leading edge; and
a gas turbine engine coupled to the wing, the engine defining an axial centerline therethrough along the longitudinal direction, the engine comprising:
a nacelle comprising an outer wall extended around the axial centerline, wherein the nacelle defines a radial reference plane extended perpendicular from the axial centerline, and wherein the outer wall defines an outer wall point closest to the fuselage, and further wherein the radial reference plane extends through a reference line defined along the latitudinal direction from the outer wall point to the leading edge of the wing; and
a low pressure (LP) turbine rotor comprising an upstream-most first turbine rotor concentric to the axial centerline, wherein the first turbine rotor is disposed downstream along the longitudinal direction of the radial reference plane.

2. The aircraft of claim 1, wherein the engine defines a top dead center (TDC) reference plane extended in the latitudinal direction from the axial centerline and intersecting the leading edge of the wing, and wherein the engine further defines a second radial reference plane extended perpendicular from the axial centerline at the intersection of the TDC reference plane, and wherein the LP turbine is disposed downstream along the longitudinal direction of the second radial reference plane.

3. The aircraft of claim 1, wherein the nacelle defines a third radial reference plane extended perpendicular from the axial centerline and extended through a third reference line defined along the latitudinal direction from a second outer wall point to the leading edge of the wing, wherein the second outer wall point is farthest from the fuselage on the outer wall, and wherein the LP turbine is disposed downstream along the longitudinal direction of the third radial reference plane.

4. The aircraft of claim 1, wherein the gas turbine engine further comprises an outer casing, wherein the outer casing comprises an outer casing wall extended around the axial centerline, and wherein the outer casing defines a fourth radial reference plane extended perpendicular from the axial centerline, wherein the outer casing wall defines an outer casing wall point closest to the fuselage on the outer casing wall, and wherein the fourth radial reference plane extends through a fourth reference line defined along the latitudinal direction from the outer casing wall point to the leading edge of the wing, and wherein the LP turbine is disposed downstream along the longitudinal direction of the fourth radial reference plane.

5. The aircraft of claim 1, wherein the gas turbine engine further comprises an outer casing, wherein the outer casing comprises an outer casing wall around the axial centerline, and wherein the outer casing defines a fifth radial reference plane extended perpendicular from the axial centerline, wherein the outer casing wall defines a second outer casing wall point farthest from the fuselage on the outer casing wall, and wherein the fifth radial reference plane extends through a fifth reference line defined along the latitudinal direction from the second outer casing wall point to the leading edge of the wing, and wherein the LP turbine is disposed downstream along the longitudinal direction of the fifth radial reference plane.

6. The aircraft of claim 1, wherein the LP turbine of the gas turbine engine comprises a last turbine rotor at a downstream-most end of the LP turbine, and further wherein the LP turbine defines a turbine burst area inward of the wing along the latitudinal direction and extended at a first angle along a plane of rotation of the first turbine rotor toward the upstream end and at a second angle along a plane of rotation of the last turbine rotor toward the downstream end of the gas turbine engine.

7. The aircraft of claim 6, wherein the first angle of the turbine burst area is approximately 15 degrees or less.

8. The aircraft of claim 7, wherein the first angle of the turbine burst area is approximately 3 degrees or more.

9. The aircraft of claim 6, wherein the second angle of the turbine burst area is approximately 15 degrees or less.

10. The aircraft of claim 9, wherein the second angle of the turbine burst area is approximately 3 degrees or more.

11. The aircraft of claim 6, wherein the turbine burst area inward of the wing toward the engine is defined downstream of the leading edge and forward of a trailing edge of the wing along the longitudinal direction.

12. The aircraft of claim 6, wherein the aircraft further comprises a containment shield extended over the LP turbine along the longitudinal direction approximately from the first turbine rotor to the last turbine rotor, and wherein the containment shield extends at least within a transverse turbine burst area extended generally clockwise and/or counter-clockwise from a TDC reference plane extended from the axial centerline along the latitudinal direction.

13. The aircraft of claim 12, wherein the containment shield is coupled to the wing of the aircraft and extended generally along the transverse direction.

14. The aircraft of claim 12, wherein the containment shield is coupled to an outer casing of the engine extended generally along the longitudinal direction, wherein the containment shield extends at least partially along a circumferential direction, defined around the axial centerline, from the TDC reference plane along the clockwise and/or counter-clockwise direction.

15. The aircraft of claim 14, wherein the containment shield extends approximately entirely around the LP turbine along the circumferential direction.

16. The aircraft of claim 12, wherein the containment shield is formed from a plurality of fabric sheets formed from a plurality of fibers.

17. The aircraft of claim 16, wherein the plurality of fibers includes para-aramid synthetic fibers, metal fibers, ceramic fibers, glass fibers, carbon fibers, boron fibers, p-phenylenetherephtalamide fibers, aromatic polyamide fibers, silicon carbide fibers, graphite fibers, nylon fibers, ultra-high molecular weight polyethylene fibers, or mixtures thereof.

18. The aircraft of claim 1, wherein the engine further comprises:
a fan assembly comprising a plurality of fan blades rotatably coupled to a fan rotor; and
a driveshaft coupled to the fan rotor, wherein the LP turbine is coupled to the driveshaft and disposed downstream of the fan assembly, and further wherein the engine defines a direct drive gas turbine engine.

19. The aircraft of claim 18, wherein the fan assembly, the LP turbine, and the driveshaft of the gas turbine engine together define a low pressure spool, and wherein the low pressure spool rotates about an axial centerline of the gas turbine engine at approximately 6000 RPM or less.

20. The aircraft of claim 1, wherein the wing defines a wing shear center, wherein the gas turbine engine further comprises:
an exhaust nozzle disposed downstream of the LP turbine, wherein the exhaust nozzle defines a downstream-most end, and wherein the downstream-most end is approximately equal to the wing shear center along the longitudinal direction.
